(19) United States
(12) Patent Application Publication
(10) Pub. No.: US 2010/0018374 A1
(43) Pub. Date: Jan. 28, 2010

(54) Cutting machine and method of measuring clearance

(75) Inventor: Tooru KUMAMOTO, Kumamoto (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki-shi (JP)

(21) Appl. No.: 12/588,040

(22) Filed: Oct. 1, 2009

(30) Foreign Application Priority Data
Jun. 10, 2008 (JP) 2008-259938

(51) Int. Cl. B26D 9/00; B26D 7/00; G01B 11/14

(52) U.S. Cl. 83/518; 83/520; 356/614

(57) ABSTRACT

A cutting machine including a die, and a cutting punch having a cutting edge, and configured to bring the cutting punch close to the die to have the cutting edge face to a surface of the die thereby cut a work, the cutting punch being provided with a local slope, wherein the cutting machine is configured, using a light source, to irradiate a light such that the light transmit through the clearance between the cutting punch and the surface of the die and to reflect on the local slope such that the direction of the path of the light is changed so as to yield reflected light to be observed is provided.

This application is based on Japanese patent application No. 2008-259938 the content of which is incorporated hereinto by reference.

### BACKGROUND

1. Technical Field

The present invention relates to a cutting machine, and a method of measuring a clearance.

2. Related Art

Semiconductor device, having a plurality of outer leads on the outer periphery of an encapsulation resin which contains a semiconductor chip encapsulated therein, may be manufactured by the procedures below. First, the semiconductor chip is placed on a leadframe, and the semiconductor chip is encapsulated by a resin. The encapsulation resin is then deburred, and the lead frame, if provided as externally unfinished, is subjected to external finishing such as plating. The semiconductor device is then cut off from the leadframe. If the semiconductor device is of surface mounting type, the cutting-off from the leadframe is followed by forming. More specifically, the outer leads horizontally projected are bent downwards, and then into the horizontal direction to thereby obtain a gull-wing geometry.

FIGS. 8A and 8B are schematic drawings illustrating an exemplary semiconductor device, wherein FIG. 8A is a plan view of a semiconductor device 200, and FIG. 8B is a sectional view taken along line A-A′ in FIG. 8A.

A plurality of outer leads (simply referred to as “leads”, hereinafter) 202 are provided on the side faces of the encapsulation resin 201 having the semiconductor chip encapsulated therein. For example, the thickness of the lead 202 is 0.125 to 0.150 mm (millimeter), and the width is approximately 0.2 mm. The leads 202 are provided with a plated film on the upper and lower surfaces thereof (excluding the cut surface of the leads). In this configuration, the total thickness of the lead frame measured in the vertical direction is 0.125 to 0.180 mm or around, while taking the thickness of the plated film into account.

An exemplary process of forming the leads of the semiconductor device 200 is illustrated in FIGS. 9A to 9C. In this process, the leads 202 are once cut to have a length a little longer than finally required (FIG. 9A), bent into a predetermined geometry (FIG. 9B), and then cut to have a specified length (FIG. 9C). Another exemplary process of forming the leads of the semiconductor device is illustrated in FIGS. 10A to 10C. In this process, the leads 202 are cut to have a specified length (FIG. 10A, FIG. 10B), and then bent into a predetermined geometry (FIG. 10C).

FIG. 11 illustrates a local configuration of a cutting machine used for cutting the leads 202. The cutting machine includes a die 106 and a cutting punch 110. The leads 202 are cut after placing them on the die 106, by moving the cutting punch 110 towards the die 106 and by inserting the cutting punch 110 into a slit of the die 106. A gap between the cutting punch 110 and the die 106, formed in the state of full insertion of the cutting punch 110 into the slit of the die 106 is now referred to as clearance of cutting (or simply “clearance”, hereinafter).

As illustrated in FIG. 11, the clearance appears at two sites, a clearance “a” on the left and a clearance “b” on the right. If two these clearances “a” and “b” differ from each other as illustrated in FIG. 11 (a≠b), non-conformities such as:

(1) cutting failure and abnormal cut surface of the leads, due to time lag of cutting between both sides; and

(2) uneven wear and shortened service life of cutting punch 110 and the die 106, and fracture of the cutting punch 110, due to the lateral stress induced on the cutting punch 110 caused by time lag of cutting between both sides,

may more likely to occur. For this reason, the clearance on both sides are basically adjusted in a balanced manner. If the relation of clearance of a=b holds, a value of clearance of the relevant cutting machine may be understood by measuring the clearance only on either side.

Japanese Laid-Open Patent Publication No. 2003-230919 describes a press machine which includes an upper die having a blanking punch, and a lower die having a blanking die which has a blank through which a work is blanked into a predetermined geometry. The blanking die has a plurality of die blocks dividably opposed so as to form the blank, and further has a plurality of spacers for moving at least one die block to a predetermined position, when a clearance between the blanking punch and the blanking die is adjusted by relocating the blank. According to the description, the configuration allows finer adjustment of the clearance of blanking.

Japanese Laid-Open Patent Publication No. S64-1902 describes a method of measuring a clearance between a punch and a die of press dies, wherein the clearance between the punch and the die in a final state of assembly of the press dies is measured by an optical means kept in contact neither with the punch nor the die. In this configuration, an optical unit is moved in parallel with the top surface of a die plate so as to bring one point of the end face of the die into focus under an objective lens, and an obtained image is projected onto a monitor.

Japanese Laid-Open Patent Publication No. H07-211838 describes a device of cutting leads of semiconductor device, configured by a die and a punch. In the lead cutting apparatus, the punch and the die are disposed so as to keep therebetween a clearance Ta equivalent to 14 to 21% of the total thickness of a lead and solder layers on the top and back thereof, and are configured to allow the punch to move in the vertical direction.

Process of lead cutting largely affects outer dimension of final products of semiconductor devices, and reliability of bonding in mounting process. In particular, the clearance is a critical issue, so that optimum conditions have been calculated by various evaluations and so forth. Consider now an exemplary case of adopting a preferable range described in Japanese Laid-Open Patent Publication No. H07-211838. Given that the total thickness of a leadframe of a semiconductor device in the vertical direction is 0.125 to 0.180 mm or around, the clearance will be given as 18 to 38 μm or around. The clearance, set to such a narrow range of several micrometers to several tens micrometers, will be very difficult to be measured from physical and technical points of view. For this reason, at present, the clearance is calculated based on the outer dimension of a punch, which is a working component of the dies, and the inner dimension of an opposing die. The clearance may, therefore, be adjusted and presumed based on only indirect information such as observed state of processing of the work (semiconductor device) mainly on the cut surface of the lead, at the best.

Japanese Laid-Open Patent Publication No. S64-1902 describes the method of measuring a clearance between a punch and a die using an optical means, but actual site of cutting has no space for accommodating a measuring instrument or a measuring element from the structural viewpoint of the die, and this makes the measurement physically difficult.

### SUMMARY

According to the present invention, there is provided a cutting machine including a die, and a cutting punch having a cutting edge, and configured to bring the cutting punch close to the die to have the cutting edge face to a surface of the die thereby cut a work, the cutting punch being provided with a local slope, wherein the cutting machine is configured, using a light source, to irradiate a light such that the light transmit through the clearance between the cutting punch and the surface of the die and to reflect on the local slope such that the direction of the path of the light is changed so as to yield reflected light to be observed.

According to the present invention, there is provided also a method of measuring a clearance using the cutting machine described in the above, configured to measure light reflected on the local slope.

By virtue of these configurations, the light transmitted through the clearance may be bent at a predetermined angle by the local slope. Accordingly, the clearance may readily be measured based on the state of transmission, even if the clearance cannot directly be observed. For an exemplary case where the die is placed on the lower side and the cutting punch is placed on the upper side, and a work is cut by moving the cutting punch downwardly towards the die, it may be preferable to provide the cutting punch with a local slope. In this configuration, light irradiated on the local slope may be reflected thereon, and may be observed typically in the lateral direction. Accordingly, the clearance may visually be measured. This way of measurement enables setting of a fine clearance, and enables also a simple and highly-reliable management of state of dies.

It is to be understood that also any arbitrary combinations of the above-described constituents, and also any exchanges in the expression of the present invention among the method, apparatuses and so forth are valid as embodiments of the present invention.

According to the present invention, in a cutting machine composed of a cutting punch and a die, a clearance between the cutting punch and the die may readily be measured.

### BRIEF DESCRIPTION OF THE DRAWINGS

The above and other objects, advantages and features of the present invention will be more apparent from the following description of certain preferred embodiments taken in conjunction with the accompanying drawings, in which:

FIGS. 1A and 1B are sectional views illustrating a configuration of a cutting machine according to one embodiment of the present invention;

FIG. 2 is a drawing illustrating, in detail, an exemplary configuration of a die, a cutting punch and a light source in one embodiment of the present invention;

FIG. 3 is a sectional view illustrating, in further detail, the configuration of the cutting punch;

FIG. 4 is a drawing illustrating a method of measuring a beam width of light reflected on a local slope of the cutting punch;

FIG. 5 is a drawing illustrating, in detail, an exemplary configuration of the die, the cutting punch and the light source in another embodiment of the present invention;

FIG. 6 is a drawing illustrating, in detail, an exemplary configuration of the die, the cutting punch and the light source in still another embodiment of the present invention;

FIG. 7 is a drawing illustrating, in detail, an exemplary configuration of the die, the cutting punch and the light source in still another embodiment of the present invention;

FIGS. 8A and 8B are schematic drawings illustrating an exemplary semiconductor device;

FIGS. 9A to 9C are drawings illustrating an exemplary forming process of the lead;

FIGS. 10A to 10C are drawings illustrating an another exemplary forming process of the lead;

FIG. 11 is a drawing partially illustrating an exemplary configuration of a cutting machine for cutting leads;

FIG. 12A is a plan view illustrating a configuration of one example of a die shown in FIGS. 1A and 1B;

FIG. 12B is a plan view illustrating a configuration of one example of a die and a cutting punch shown in FIGS. 1A and 1B;

FIG. 13A is a plan view illustrating a configuration of another example of a die shown in FIGS. 1A and 1B;

FIG. 13B is a plan view illustrating a configuration of another example of a die and a cutting punch shown in FIGS. 1A and 1B;

FIG. 14A is a plan view illustrating a configuration of one example of a die shown in FIG. 6; and

FIG. 14B is a plan view illustrating a configuration of one example of a die and a cutting punch shown in FIG. 6.

### DETAILED DESCRIPTION

The invention will now be described herein with reference to an illustrative embodiment. Those skilled in the art will recognize that many alternative embodiments can be accomplished using the teachings of the present invention and that the invention is not limited to the embodiments illustrated for explanatory purposes.

Paragraphs below will explain embodiments of the present invention, referring to the attached drawing. Note that any similar constituents in all drawings will be given with similar reference numerals or symbols, and explanations therefor will not be repeated on occasions.

This embodiment will be explained referring to a case where the cutting machine is a lead cutting apparatus for cutting leads of semiconductor devices. In this case, the work is a group of leads.

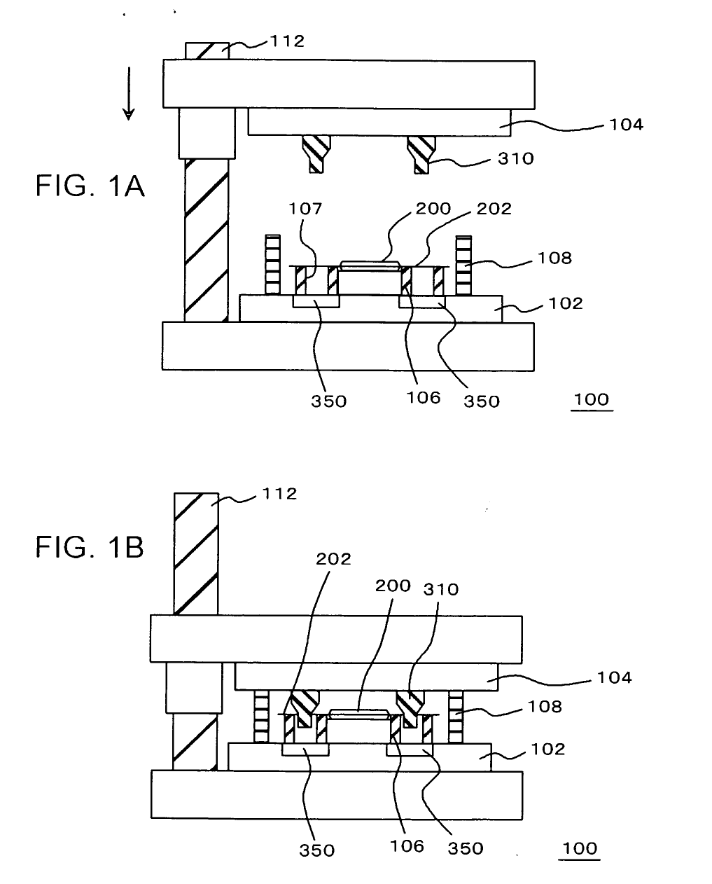

FIGS. 1A and 1B are sectional views illustrating a configuration of a cutting machine of this embodiment. Note that FIGS. 1A and 1B illustrate only the bare minimum of elements necessary for explaining the embodiment of the present invention, while leaving any components necessary for ensuring and improving rigidity and strength of the dies unillustrated.

A cutting machine 100 contains a lower die 102, an upper die 104, a die 106 and an upper die supporting block 108 attached to the lower die 102, a cutting punch 310 attached to the upper die 104, and a support 112 holding the upper die 104 in a vertically movable manner. The die 106 allows thereon placement of a semiconductor device 200. The cutting punch 310 and the die 106 may be configured using alloy tool steel, high-speed tool steel, cemented carbide alloy or the like.

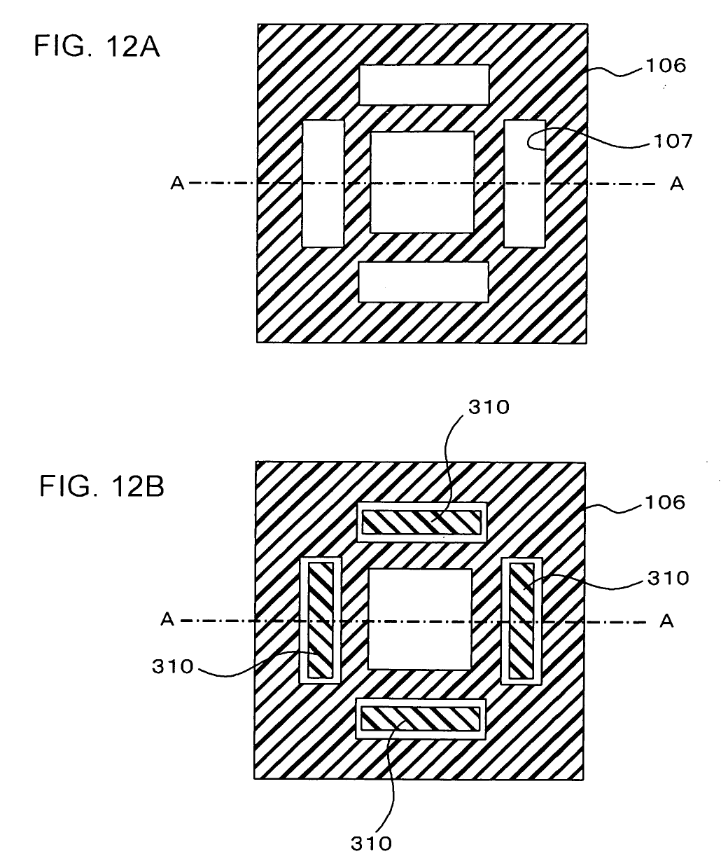

FIG. 12A is a plan view illustrating a configuration of one example of the die 106 shown in FIGS. 1A and 1B. Here, four slits 107 are provided in the die 106 such that the slits 107 respectively surround the four sides of the portion where the semiconductor device 200 is placed. In such the case, the semiconductor device 200 may be QFP that includes a group of leads at its four sides. FIG. 12B is a plan view illustrating a configuration of one example of the die 106 and the cutting punches 310 shown in FIGS. 1A and 1B. As shown in FIG. 12B, four cutting punches 310 are attached to the upper die 104 such that each of the cutting punches 310 corresponds to each of the four slits 107. The die 106 and the cutting punches 310 shown in FIGS. 1A and 1B correspond to sectional views taken A-A line in FIGS. 12A and 12B.

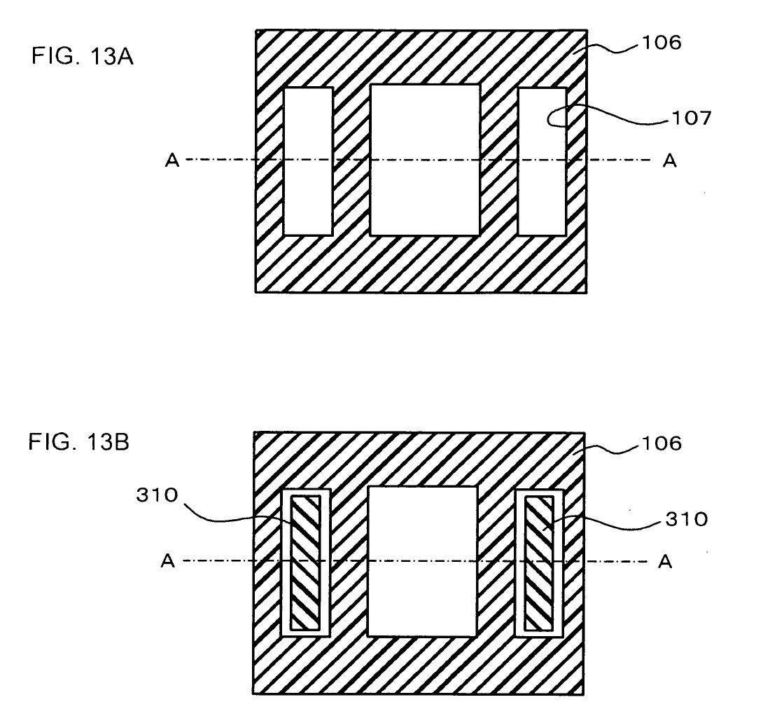

FIG. 13A is a plan view illustrating a configuration of another example of the die shown in FIGS. 1A and 1B. In this example, two slits 107 are provided in the die 106 such that the slits 107 respectively formed at both sides of the portion where the semiconductor device 200 is placed. In such the case, the semiconductor device 200 may be SOP that includes a group of leads at its both sides. FIG. 13B is a plan view illustrating a configuration of another example of the die 106 and the cutting punches 310 shown in FIGS. 1A and 1B. As shown in FIG. 13B, two cutting punches 310 are attached to the upper die 104 such that each of the cutting punches 310 corresponds to each of the two slits 107. The die 106 and the cutting punches 310 shown in FIGS. 1A and 1B correspond to sectional views taken A-A line in FIGS. 13A and 13B.

The cutting machine 100 in this embodiment is aimed at blank shearing in which cutting punch 310 blanks a group of leads 202 as a work. The cutting machine 100 allows forward blanking in which the cutting punch 310 operates in the direction of gravity. The leads 202 are cut by vertically moving the upper die 104 along the support 112 assumed as an axis, with the aid of motive force of a press machine (not illustrated). FIG. 1A is a drawing illustrating a state before the leads 202 are cut, and FIG. 1B is a drawing illustrating a state of cutting of the leads 202 by the cutting punch 310. The upper die 104 stops in the state illustrated in FIG. 1B, while being butted with the upper die supporting block 108 provided to the lower die 102.

The cutting machine 100 is provided also with light sources 350 emitting beams of light, from behind (from the lower side or the other surface of in this embodiment of) the die 106, which are allowed to transmit through the clearance between the die 106 (the side surface of the die 106) and the cutting punch 310. The light sources 350 may be of built-in type attached to the lower die 102, or may alternatively be of attached type detachable from the lower die 102 if necessary. Even for the case of the built-in type, the light sources 350 may be configured to be movable, so as to be moved below the die 106 only when the clearance is measured. Alternatively, the light sources 350 configured as of the attached type may be provided to an equipment on which the lower die 102 is mounted.

Each light source 350 may be configured as a light source device or a light source element. The light source 350 may be any of those visually observable such as LED (Light Emitting Diode), or coherent ones such as laser element. The light source 350 adoptable herein may be any of those satisfying criteria for selection, such as generality, wavelength characteristics of the transmitted light (shortness in wavelength) and so forth.

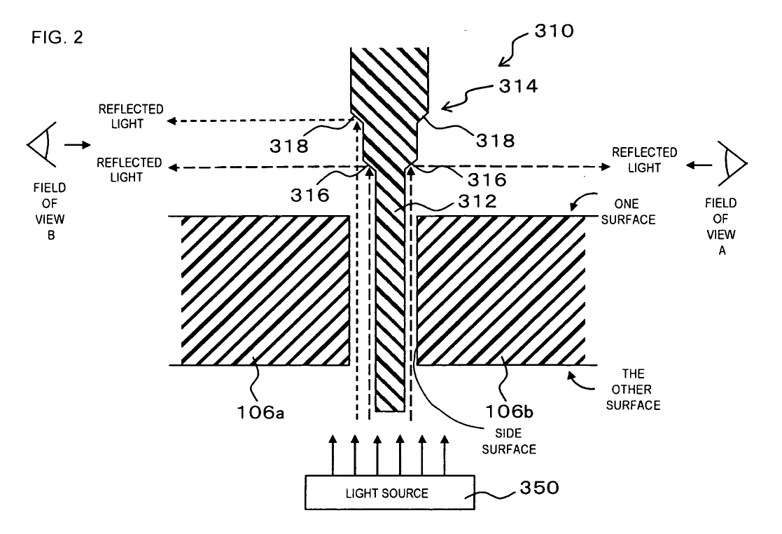

FIG. 2 is a drawing illustrating, in detail, an exemplary configuration of the die, the cutting punch 310 and the light source 350 in this embodiment. In FIG. 2, the die on the left side of the cutting punch 310 in the drawing is denoted as 106a, and the die on the right side is denoted as 106b, for convenience of explanation. In FIG. 2, the upper side of the die 106a and 106b is defined as “one surface”.

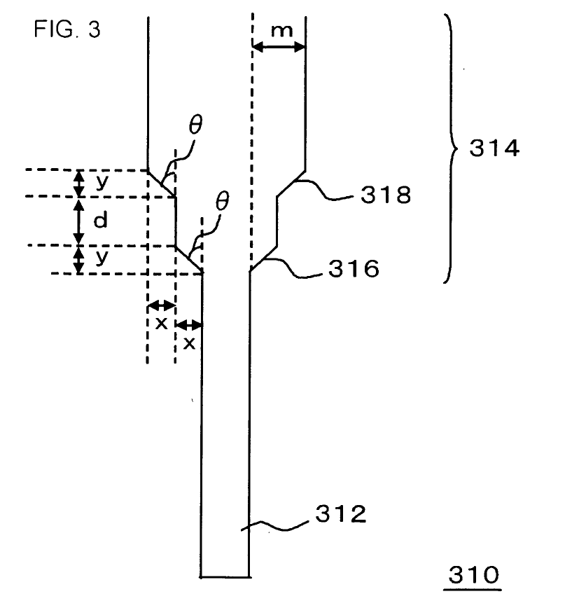

FIG. 3 is a sectional view illustrating, in further detail, the configuration of the cutting punch 310.

The cutting punch 310 includes a portion of cutting 312, and a stepped portion for measurement 314. The portion of cutting 312 of the cutting punch 310 is provided with a cutting edge for cutting the leads 202 of the semiconductor device 200, on the surface thereof facing to (or opposed to) the side surface of the die 106. The cutting edge herein may be provided at least to the edge of the surface of the cutting punch 310 facing to the side surface of the die 106. In this embodiment, the cutting edge may be configured by the entire surface, facing to the side surface of the die 106, of the portion of cutting 312 of the cutting punch 310. In the portion of cutting 312, the surface roughness value Ra of the cutting edge may be 0.05 or smaller (where, Ra means an arithmetic mean roughness, and more specifically an average value of absolute deviations from an average level of height). This configuration may stably form sheared surface on the cut surface of the leads 202, and may improve a ratio of formation of plated film on the sheared surface.

In this embodiment, the stepped portion for measurement 314 of the cutting punch 310 is provided with local slopes, each of which is inclined at a predetermined angle θ away from the direction of movement of the cutting punch 310 in the process of cutting the leads 202, so as to expand the cross section of the cutting punch in the direction departing from the die 106. In this embodiment, a plurality of steps of local slopes are provided to the stepped portion for measurement 314 of the cutting punch 310, in a step-by-step manner. More specifically, the stepped portion for measurement 314 of the cutting punch 310 is provided with local slopes 316 and local slopes 318. In this embodiment, each local slope 316 and each local slope 318 are provided to each of the surfaces of the cutting punch 310 facing to the dies 106a and 106b.

As illustrated in FIG. 3, each of the local slopes 316 and the local slopes 318 has width “x” in the direction of measurement of clearance (lateral direction in the drawing), and width “y” in the direction of movement of the cutting punch 310 (vertical direction in the drawing). In this embodiment, the local slopes 316 and the local slopes 318 are formed so as to keep a predetermined angle θ of 45° away from the direction of movement of the cutting punch 310 in the process of cutting the leads 202 (in the vertical direction in the drawing). As a consequence, also the angles of the local slopes 316 and the local slopes 318 away from the horizontal plane may be given as 45°. In this case, the relation of width of x=y holds. Each of the local slopes 316 and the local slopes 318 may be configured by a smooth surface, so as to successfully reflect incident light. Each of the local slopes 316 and the local slopes 318 may be configured by a flat surface, so as to reflect the incident light into a single direction.

Next, a method of measuring the clearance will be explained. For convenience of explanation, FIG. 2 illustrates an exemplary case where the clearances on the left side and on the right side of the cutting punch 310 are unbalanced. In the drawing, the clearance between the die 106a on the left side and the cutting punch 310 is larger than the clearance between the die 106b on the right side and the cutting punch 310.

In the process of measuring the clearance, a light source 350 is disposed below the die 106a and the die 106b. When light is irradiated in this configuration in the direction from the light source 350 towards the cutting punch 310, the beams of light transmitted through the clearances are reflected on the slope 316 and the local slope 318, and are thereby changed in the direction of propagation. Since the angle of inclination of the local slopes 316 and the local slopes 318 is set to 45°, the path of the light emitted from the light source 350 is changed or bent by 90° at the local slope 316 and the local slope 318, to thereby yield the reflected light in the lateral direction in the drawing. Accordingly, the reflected light may be seen, by visually observing the stepped portion for measurement 314 of the cutting punch 310 in the lateral direction (in the fields of view “A” and “B”).

It is now assumed that the relation of width of x=y=3 μm, for example, is given. In this case, if the clearance between the cutting punch 310 and either of the die 106a and the die 106b is 3 μm or smaller, the light emitted from the light source 350 is irradiated only on the local slope 316, but not on the local slope 318. On the other hand, if the clearance between the cutting punch 310 and either of the die 106a and the die 106b is larger than 3 μm, the light emitted from the light source 350 is irradiated also on the local slope 318 in addition to the local slope 316. If the light is irradiated also on the local slope 318, two beams of light reflected on the local slope 316 and on the local slope 318 are observed. Accordingly, the clearance may be understood by observing the reflected light in the fields of view “A” and “B”.

In this embodiment, as illustrated in FIG. 3, the local slopes 316 and the local slopes 318 may be disposed at an interval d in the direction of movement of the cutting punch 310 (vertical direction in the drawing). Accordingly, a wide distance may be kept between the beams of light reflected on the local slope 316 and the local slope 318, so that whether the clearance between the cutting punch 310 and either of the die 106a and the die 106b is not larger than the width x or larger than the width x may readily be understood even by visual observation. The cutting punch 310, exemplarily having two steps of local slopes, may alternatively be provided with a larger number of steps of local slopes in the direction of movement of the cutting punch 310. By finely setting the dimension of each local slope and by disposing the individual local slopes at intervals in the direction of movement of the cutting punch 310 (vertical direction in the drawing), the clearance may be finely understood only by visual observation.

As illustrated in FIG. 3, the total width m of the local slopes in the stepped portion for measurement 314 of the cutting punch 310 in the lateral direction in the drawing may be set not smaller than a possible maximum value of the clearance between the cutting punch 310 and either of the die 106a and the die 106b. For example, the clearance of lead cutting dies used for manufacturing semiconductor devices are generally set to several micrometers to several tens micrometers. The total width m of the local slopes in the stepped portion for measurement 314 of the cutting punch 310 may be set larger than the clearance of the lead cutting dies.

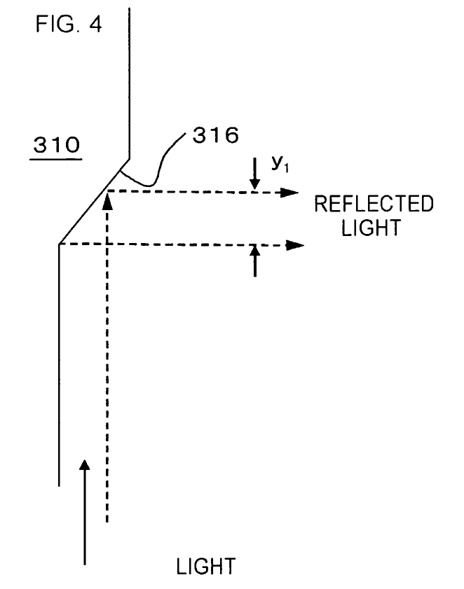

Further as illustrated in FIG. 4, more detailed clearance may be measured by capturing the width of beams of light reflected on the local slopes 316, at a large magnification typically by an image processing camera equipped with a linear CCD or a two-dimensional CCD, and by raising resolution of measurement on the single pixel basis. More specifically, a precise value of clearance may be obtained by finely measuring the beam width y₁ of the light reflected on the local slope 316.

By virtue of the above-described configuration, the clearance which is a gap between the cutting punch 310 and the die 106 (die 106a, die 106b) may directly be projected with the aid of the light source 350. The beams of light transmitted through the clearances are reflected on the local slopes 316 which are provided to the cutting punch 310, while being preliminarily finished to have a predetermined dimension, and are output outwardly in the horizontal direction. The clearances may visually be measured in a simple manner, by observing the reflected beams of light. Accordingly, the measurement of clearance, which has conventionally been difficult, may readily be conducted without using any measuring instrument. By virtue of addition of this function, it is now possible to realize highly reliable management of state of dies based on fine setting of clearance and confirmation through actual measurement, and thereby to provide high-quality semiconductor devices.

Next, another example of the cutting punch 310 will be explained.

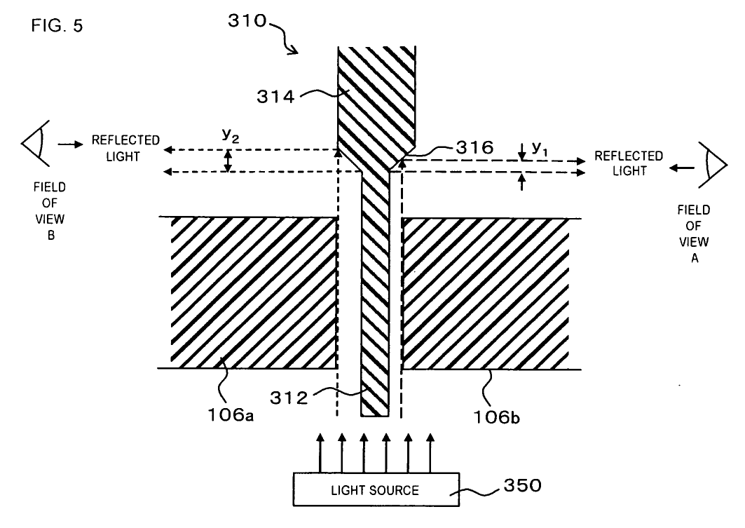

While the cutting punch 310 illustrated in FIG. 2 and FIG. 3 is configured to have a plurality of sets of local slopes in the direction of movement thereof, the cutting punch 310 may alternatively have only a single set of local slopes 316 as illustrated in FIG. 5. Also in this case, similarly to as illustrated in FIG. 4, more detailed clearance may be measured by capturing the beam widths y₁ and y₂ of light reflected on the local slopes 316 at a large magnification typically by image processing cameras.

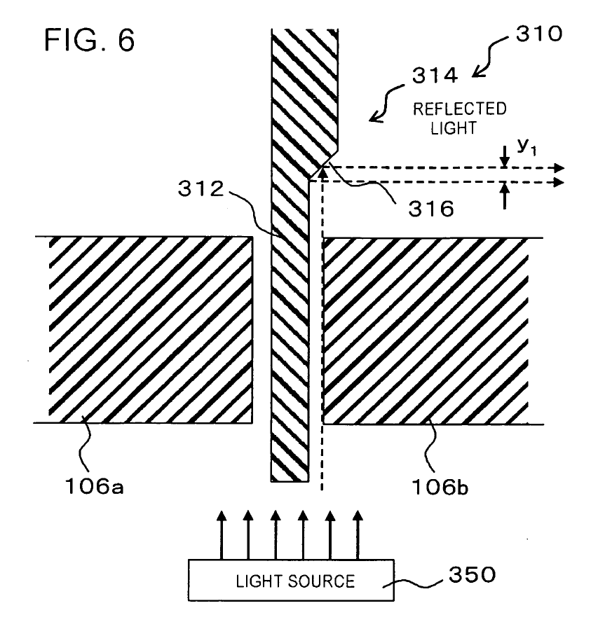

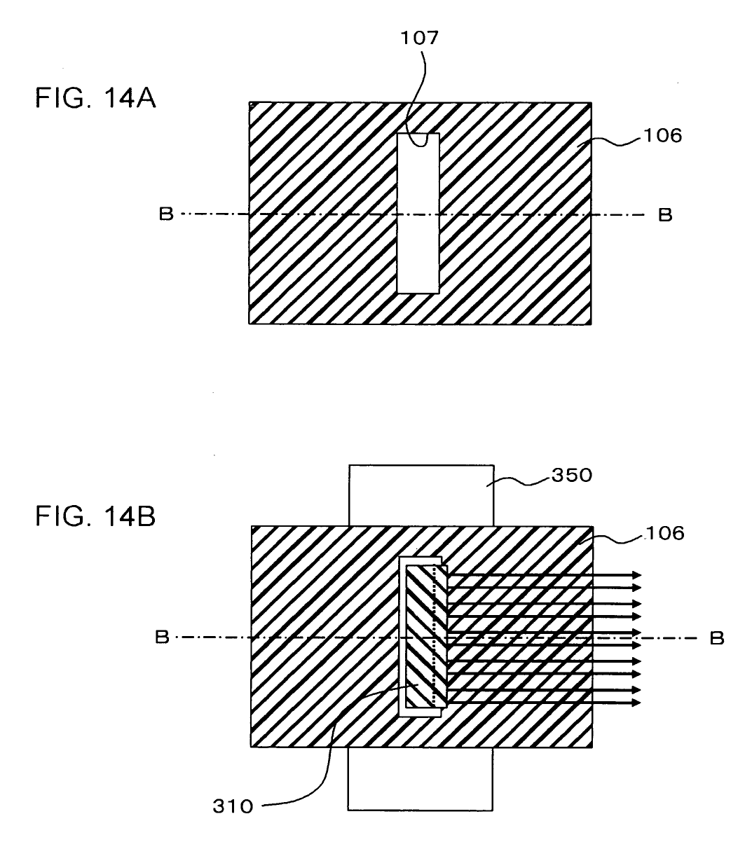

FIGS. 1A to 5 illustrated the exemplary cases where the local slopes are provided to the cutting punch 310 on both of the surfaces thereof facing to the die 106a and facing to the die 106b. The local slope may alternatively be provided to only either one of the surfaces as illustrated in FIG. 6. FIG. 14A is a plan view illustrating a configuration of one example of the die 106 shown in FIG. 6. Here, one slit 107 is provided in the die 106. In such the case, the semiconductor device 200 may be SOP that includes a group of leads at its one side. FIG. 14B is a plan view illustrating a configuration of one example of the die 106 and the cutting punch 310 shown in FIG. 6. In FIG. 14B, the light sources 350 provided below the die 106 and the beams of light reflected at the local slope 316 are also shown. The die 106 and the cutting punche 310 shown in FIG. 6 correspond to sectional views taken B-B line in FIGS. 14A and 14B. Also in this configuration, by measuring the clearance on one side, the clearance on the other side may be calculated based on the measured value, distance between the die 106a and the die 106b, and the width of the portion of cutting 312 of the cutting punch 310. While FIG. 6 illustrated an exemplary case where only a single step of the local slope 316 was provided to the cutting punch 310, a plurality of steps of local slope (for example, the local slopes 316 and 318) may be provided as illustrated in FIG. 3.

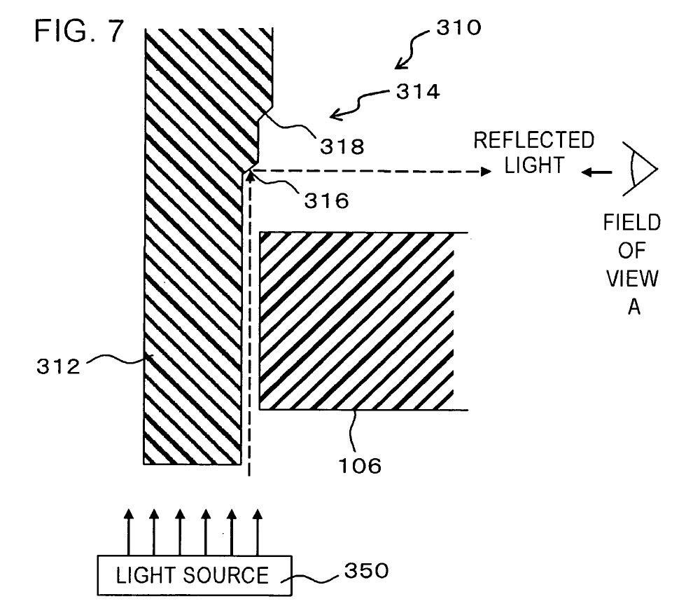

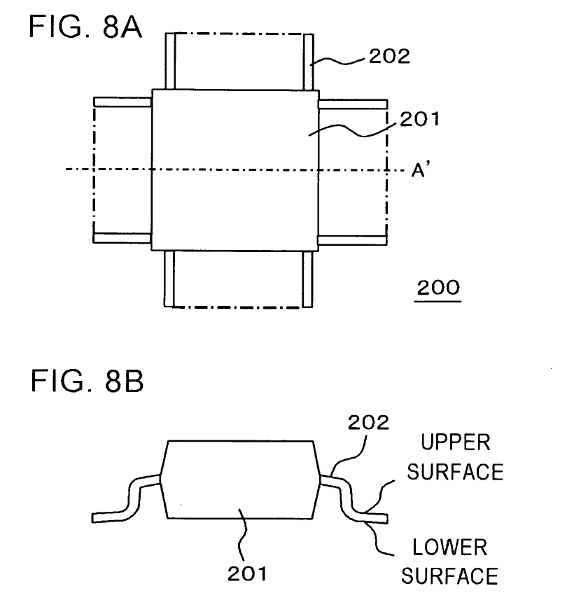

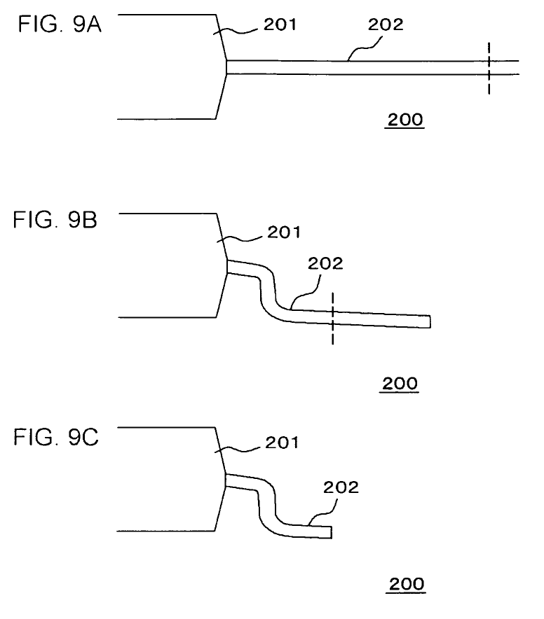

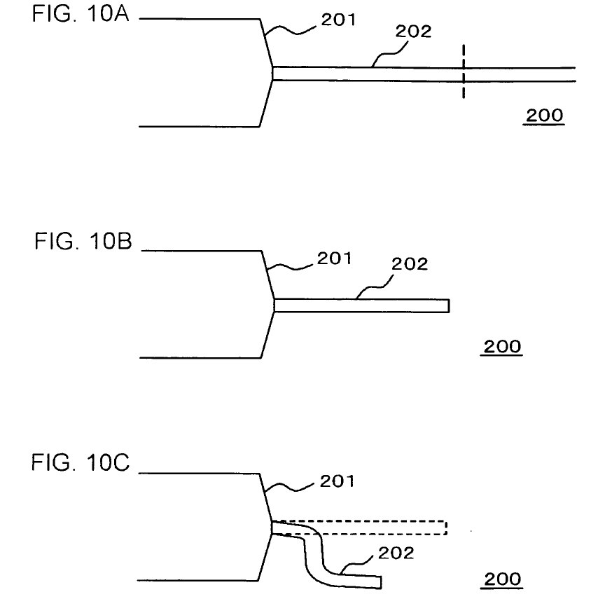

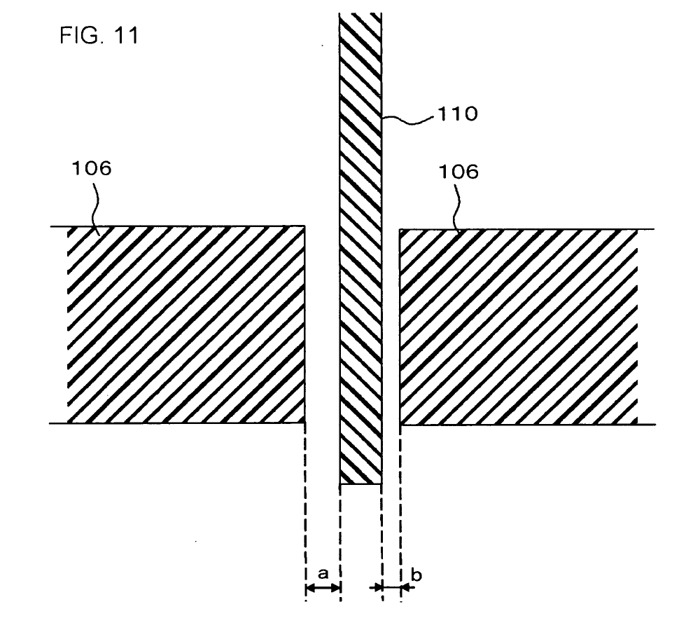

In the exemplary cases illustrated in FIGS. 1A to 6, the cutting machine 100 is aimed at blank shearing in which cutting punch 310 blanks a group of leads 202 as a work. The cutting machine 100 may alternatively be configured to effect cutting such as shear cutting in which the work is cut only at a single point facing to one side face of the cutting punch 310. FIG. 7 illustrates this example. FIG. 7 illustrates an exemplary case where the stepped portion for measurement 314 of the cutting punch 310 is provided with a plurality of steps of local slopes 316 and the local slopes 318 step by step, similarly to as illustrated in FIG. 3, while allowing an alternative configuration having only a single step of local slope 316 provided thereto, similarly to as illustrated in FIG. 5.

The embodiments of the present invention have been described in the above referring to the attached drawings, merely as examples of the present invention, without being precluded from adoption of any other various configurations.

Although not illustrated, the configuration of the cutting punch 310 may be adoptable also to the cutting machine 100 having a die attached to the upper die, and having a cutting punch 310 attached to the lower die, so as to effect shear blanking or cutting based on the reverse blanking in which the cutting punch 310 moves upward to cut a work.

It is apparent that the present invention is not limited to the above embodiment, that may be modified and changed without departing from the scope and spirit of the invention.

What is claimed is:

1. A cutting machine comprising a die, and a cutting punch having a cutting edge, and configured to bring said cutting punch close to said die to have said cutting edge face to a surface of said die thereby cut a work, said cutting punch being provided with a local slope,
wherein said cutting machine is configured, using a light source, to irradiate a light such that the light transmit through the clearance between said cutting punch and said surface of said die and to reflect on said local slope such that the direction of the path of said light is changed so as to yield reflected light to be observed.

2. The cutting machine as claimed in claim 1,
wherein said local slope of said cutting punch is inclined at a predetermined angle so as to expand the cross section of said cutting punch in the direction departing from the light source.

3. The cutting machine as claimed in claim 2, wherein said predetermined angle is 45°.

4. The cutting machine as claimed in claim 1,
wherein said cutting punch has a plurality of said local slopes provided thereto so as to form steps.

5. A method of measuring a clearance using the cutting machine described in claim 1,
configured to measure light reflected on said local slope to thereby measure said clearance.

6. The method of measuring a clearance as claimed in claim 5,
configured to measure the beam width of light reflected on said local slope to thereby measure said clearance.
